(19) United States
(12) Patent Application Publication
(10) Pub. No.: US 2024/0352165 A1
(43) Pub. Date: Oct. 24, 2024

(54) PROPYLENE ETHYLENE COPOLYMER

(71) Applicant: Basell Poliolefine Italia S.r.l., Milano (IT)

(72) Inventors: Davide Tartari, Ferrara (IT); Gilberto Moscardi, Ferrara (IT); Monica Galvan, Ferrara (IT)

(73) Assignee: Basell Poliolefine Italia S.r.l., Milano (IT)

(21) Appl. No.: 18/684,539

(22) PCT Filed: Aug. 16, 2022
(86) PCT No.: PCT/EP2022/072854

§ 371 Date: Feb. 16, 2024

(30) Foreign Application Priority Data
Aug. 24, 2021 (EP) 21192746.2

(51) Int. Cl. C08F 210/16; C08J 5/18; E02D 17/20; E04D 5/08

(52) U.S. Cl. CPC C08F 210/16; C08J 5/18; C08F 2800/20; C08J 2323/16; E02D 17/20; E02D 2300/0006; E04D 5/08

(57) ABSTRACT

A propylene ethylene copolymer having:
i) a xylene soluble fraction at 25° C. ranging from 30 wt % to 48 wt %;
ii) an intrinsic viscosity of the xylene soluble fraction, ranging from 2.8 to 4.3 dl/g;
iii) a melt flow rate, measured according to ISO 1133 at 230° C. with a load of 2.16 kg, ranging from 0.2 g/10 min to 10 g/10 min;
iv) an ethylene derived units content ranging from 10.3 wt % to 15.4 wt %;
v) the ethylene derived units content on the xylene insoluble fraction, ranging from 6.1 wt % to 9.0 wt %;
vi) the ethylene derived units content on the xylene soluble fraction, ranging from 18.2. wt % to 30.2 wt %;
vii) the ¹³C-NMR sequences PEP measured on the xylene insoluble fraction, ranging from 4.1 mol % to 6.5 mol %; and
(viii) the ¹³C-NMR sequences PEP measured on the xylene soluble fraction, ranging from 10.5 mol % to 14.2 mol %.

### FIELD OF THE INVENTION

In general, the present disclosure relates to the field of chemistry. More specifically, the present disclosure relates to polymer chemistry. In particular, the present disclosure relates to a propylene ethylene copolymer and articles made therefrom.

### BACKGROUND OF THE INVENTION

In some instances, polyolefin compositions have elastic properties and demonstrate thermoplastic behavior. In some instances, those polyolefin compositions are used in many application fields because the polyolefins also have chemical inertia, mechanical properties, and nontoxicity.

In some instances, the polyolefin compositions are transformed into finished products with techniques used for thermoplastic polymers.

### SUMMARY OF THE INVENTION

In a general embodiment, the present disclosure provides a propylene ethylene copolymer having:
i) a xylene soluble fraction at 25° C. ranging from 30 wt % to 48 wt %, based upon the total weight of the propylene ethylene copolymer;
ii) an intrinsic viscosity of the fraction soluble in xylene at 25° C., measured in tetrahydronaphthalene at 135° C., ranging from 2.8 to 4.3 dl/g;
iii) a melt flow rate, MFR, measured according to ISO 1133-1:2012 at 230° C. with a load of 2.16 kg, ranging from 0.2 g/10 min to 10 g/10 min;
iv) an ethylene derived units content, measured by ¹³C-NMR, ranging from 10.3 wt % to 15.4 wt %, based upon the total weight of the propylene ethylene copolymer;
v) the ethylene derived units content, measured by ¹³C-NMR on the fraction insoluble in xylene at 25° C., ranging from 6.1 wt % to 9.0 wt %, based upon the total weight of the insoluble fraction;
vi) the ethylene derived units content, measured by ¹³C-NMR on the fraction soluble in xylene at 25° C., ranging from 18.2. wt % to 30.2 wt %, based upon the total weight of the soluble fraction;
vii) the ¹³C-NMR sequences PEP measured on the fraction insoluble in xylene at 25° C., ranging from 4.1 mol % to 6.5 mol %; and
viii) the ¹³C-NMR sequences PEP measured on the fraction soluble in xylene at 25° C., ranging from 10.5 mol % to 14.2 mol %.

### DETAILED DESCRIPTION OF THE INVENTION

In some embodiments, the propylene ethylene copolymer has:
i) a xylene soluble fraction at 25° C. ranging from 30 wt % to 48 wt %; alternatively from 33 wt % to 45 wt %; alternatively from 35 wt % to 42 wt %, based upon the total weight of the propylene ethylene copolymer;
ii) an intrinsic viscosity of the fraction soluble in xylene at 25° C., measured in tetrahydronaphthalene at 135° C., ranging from 2.8 to 4.3 dl/g; alternatively from 3.0 to 4.0 dl/g; alternatively from 3.2 to 3.8 dl/g;
iii) a melt flow rate, MFR, measured according to ISO 1133-1:2012 at 230° C. with a load of 2.16 kg, ranging from 0.2 g/10 min to 10 g/10 min; alternatively from 0.3 g/10 min to 8.0 g/10 min; alternatively from 0.4 g/10 min to 6.0 g/10 min;
iv) an ethylene derived units content, measured by ¹³C-NMR, ranging from 10.3 wt % to 15.4 wt %; alternatively from 11.2 wt % to 14.4 wt %; alternatively from 11.9 wt % to 13.4 wt %, based upon the total weight of the propylene ethylene copolymer;
v) the ethylene derived units content, measured by ¹³C-NMR on the fraction insoluble in xylene at 25° C., ranging from 6.1 wt % to 9.0 wt %; alternatively ranging from 6.3 wt % to 8.3 wt %; alternatively ranging from 6.5 wt % to 8.2 wt %, based upon the total weight of the insoluble fraction;
vi) the ethylene derived units content, measured by ¹³C-NMR on the fraction soluble in xylene at 25° C., ranging from 18.2. wt % to 30.2 wt %; alternatively ranging from 20.2 wt % to 27.8 wt %; alternatively ranging from 22.2 wt % to 26.5 wt %, based upon the total weight of the soluble fraction;
vii) the ¹³C-NMR sequences PEP measured on the fraction insoluble in xylene at 25° C. ranging from 4.1 mol % to 6.5 mol %; alternatively ranging from 4.3 mol % to 6.0 mol %; alternatively ranging from 4.8 mol % to 6.0 mol %; and
viii) the ¹³C-NMR sequences PEP measured on the fraction soluble in xylene at 25° C. ranging from 10.5 mol % to 14.2 mol %; alternatively ranging from 10.9 mol % to 13.8 mol %; alternatively ranging from 11.5 mol % to 13.5 mol %.

As used herein, the term “copolymer” refers to polymers containing two kinds of comonomers, in the absence of other comonomers. In some embodiments, the comonomers are propylene and ethylene.

In some embodiments and in the propylene ethylene copolymer, the ¹³C-NMR sequences PEE measured on the fraction soluble in xylene at 25° C. range from 10.3 mol % to 13.0 mol %; alternatively range from 10.8 mol % to 12.5 mol %.

In some embodiments and in the propylene ethylene copolymer, the ¹³C-NMR sequences EEE measured on the fraction soluble in xylene at 25° C. are lower than 9.0 mol % alternatively in a range from 4.5 mol % to 8.5 mol %.

In some embodiments, propylene ethylene copolymer is obtained with a process being carried out in a reactor having two interconnected polymerization zones, a riser and a downcomer, wherein the growing polymer particles:
(a) flow through the first polymerization zone, the riser, under fast fluidization conditions in the presence of propylene and ethylene;
(b) leave the riser and enter the second polymerization zone, the downcomer, through which the growing polymer particles flow downward in a densified form in the presence of propylene and ethylene, wherein the concentration of ethylene in the downcomer is higher than in the riser; and
(c) leave the downcomer and are reintroduced into the riser, thereby establishing a circulation of polymer between the riser and the downcomer.

In the first polymerization zone (riser), fast fluidization conditions are established by feeding a gas mixture made from or containing one or more alpha-olefins at a velocity higher than the transport velocity of the polymer particles. In some embodiments, the velocity of the gas mixture is between 0.5 and 15 m/s, alternatively between 0.8 and 5 m/s. As used herein, the terms “transport velocity” and “fast fluidization conditions” are as defined in “D. Geldart, Gas Fluidisation Technology, page 155 et seq., J. Wiley & Sons Ltd., 1986”.

In the second polymerization zone (downcomer), the polymer particles flow under the action of gravity in a densified form, thereby achieving the high values of density of the solid (mass of polymer per volume of reactor) and approaching the bulk density of the polymer. As used herein, the term “densified form” of the polymer indicates that the ratio between the mass of polymer particles and the reactor volume is higher than 80% of the “poured bulk density” of the polymer. In the downcomer, the polymer flows downward in a plug flow and small quantities of gas, if any, are entrained with the polymer particles.

In some embodiments, the two interconnected polymerization zones are operated such that the gas mixture coming from the riser is totally or partially prevented from entering the downcomer by introducing into the upper part of the downcomer a liquid and/or gas stream, denominated “barrier stream”, having a composition different from the gaseous mixture present in the riser. In some embodiments, one or more feeding lines for the barrier stream are placed in the downcomer close to the upper limit of the volume occupied by the polymer particles flowing downward in a densified form.

In some embodiments, this liquid/gas mixture fed into the upper part of the downcomer partially replaces the gas mixture entrained with the polymer particles entering the downcomer. The partial evaporation of the liquid in the barrier stream generates in the upper part of the downcomer a flow of gas, which moves counter-currently to the flow of descending polymer, thereby acting as a barrier to the gas mixture coming from the riser and entrained among the polymer particles. In some embodiments, the liquid/gas barrier fed to the upper part of the downcomer is sprinkled over the surface of the polymer particles. In some embodiments, the evaporation of the liquid provides the upward flow of gas.

In some embodiments, the feed of the barrier stream causes a difference in the concentrations of monomers or hydrogen (molecular weight regulator) inside the riser and the downcomer, thereby producing a bimodal polymer.

In some embodiments, the gas-phase polymerization process involves a reaction mixture made from or containing the gaseous monomers, inert polymerization diluents, and chain transfer agents to regulate the molecular weight of the polymeric chains. In some embodiments, hydrogen is used to regulate the molecular weight. In some embodiments, the polymerization diluents are selected from C₂-C₈ alkanes, alternatively from the group consisting of propane, isobutane, isopentane, and hexane. In some embodiments, propane is used as the polymerization diluent in the gas-phase polymerization.

In some embodiments, the barrier steam is made from or containing:
i. from 10 to 100% by mol of propylene, based upon the total moles in the barrier stream;
ii. from 0 to 80% by mol of ethylene, based upon the total moles in the barrier stream;
iii. from 0 to 30% by mol of propane, based upon the total moles in the barrier stream; and
iv. from 0 to 5% by mol of hydrogen, based upon the total moles in the barrier stream.

In some embodiments, the composition of the barrier stream is obtained from the condensation of a part of the fresh monomers and propane, wherein the condensed part is fed to the upper part of the downcomer in a liquid form. In some embodiments, the composition of the barrier stream is derived from condensation or distillation of part of a gaseous stream continuously recycled to the reactor having two interconnected polymerization zones.

In some embodiments, additional liquid or gas is fed along the downcomer at a point below the barrier stream.

In some embodiments, the recycle gas stream is withdrawn from a gas/solid separator placed downstream the riser, cooled by passage through an external heat exchanger, and then recycled to the bottom of the riser. In some embodiments, the recycle gas stream is made from or containing the gaseous monomers, the inert polymerization components, and chain transfer agents. In some embodiments, the inert polymerization components include propane. In some embodiments, the chain transfer agents include hydrogen. In some embodiments, the composition of the barrier stream deriving from condensation or distillation of the gas recycle stream is adjusted by feeding liquid make-up monomers and propane before the gas recycle stream's introduction into the upper part of downcomer.

In some embodiments and in both riser and downcomer, the temperature is between 60° C. and 120° C. while the pressure ranges from 5 to 40 bar.

In some embodiments, the process for preparing the propylene ethylene copolymer is carried out in presence of a highly stereospecific heterogeneous Ziegler-Natta catalyst. In some embodiments, the Ziegler-Natta catalysts are made from or containing a solid catalyst component made from or containing at least one titanium compound having at least one titanium-halogen bond and at least an electron-donor compound (internal donor), both supported on magnesium chloride. In some embodiments, the Ziegler-Natta catalysts systems are further made from or containing an organo-aluminum compound as a co-catalyst and optionally an external electron-donor compound.

In some embodiments, the catalysts systems are as described in the European Patent Nos. EP45977, EP361494, EP728769, and EP 1272533 and Patent Cooperation Treaty Publication No. WO00163261.

In some embodiments, the organo-aluminum compound is an alkyl-Al selected from the trialkyl aluminum compounds. In some embodiments, the trialkyl aluminum compound is selected from the group consisting of triethylaluminum, triisobutylaluminum, tri-n-butylaluminum, tri-n-hexylaluminum, and tri-n-octylaluminum. In some embodiments, the trialkylaluminum is mixed with alkylaluminum halides, alkylaluminum hydrides, or alkylaluminum sesquichlorides such as AlEt₂Cl and Al₂Et₃Cl₃.

In some embodiments, the external electron-donor compounds are selected from the group consisting of silicon compounds, ethers, esters, amines, heterocyclic compounds, ketones, and 1,3-diethers. In some embodiments, the ester is ethyl 4-ethoxybenzoate. In some embodiments, the external electron-donor compound is 2,2,6,6-tetramethyl piperidine. In some embodiments, theexternal donor compounds are silicon compounds of formula Rₐ⁵R_{b}⁶Si(OR⁷)_{c} where a and b are integer from 0 to 2, c is an integer from 1 to 3 and the sum (a+b+c) is 4; R⁵, R⁶, and R⁷, are alkyl, cycloalkyl or aryl radicals with 1-18 carbon atoms optionally containing heteroatoms. In some embodiments, the silicon compounds are selected from the group consisting of methylcyclohexyldimethoxysilane, diphenyldimethoxysilane, methyl-t-butyldimethoxysilane, dicyclopentyldimethoxysilane, 2-ethylpiperidinyl-2-t-butyldimethoxysilane, 1,1,1,trifluoropropyl-2-ethylpiperidinyl-dimethoxysilane, and 1,1,1, trifluoropropyl-methyldimethoxysilane. In some embodiments, the external electron donor compound is used in an amount to give a molar ratio between the organo-aluminum compound and the electron donor compound of from 0.1 to 500; alternatively from 1 to 100; alternatively from 2 to 50.

In some embodiments, the propylene ethylene copolymer compositions are further made from or containing additives.

In some embodiments, the propylene ethylene copolymer has a Shore Hardness D lower than 50, alternatively lower than 47. In some embodiments, the Shore Hardness D is higher than 10. In some embodiments, the propylene ethylene copolymer has an elongation at break (ISO 527-3, technically equivalent to the ASTM D638 norm) higher than 250%, alternatively higher than 450%. In some embodiments, the elongation at break is lower than 1000%. In some embodiments, the propylene ethylene copolymer has a tensile strength at break, transverse direction (ISO 527-3) higher than 21, alternatively higher than 22 MPa. In some embodiments, the tensile strength at break, transverse direction is lower than 200 MPa. In some embodiments, the propylene ethylene copolymer has a puncture resistance max force higher than 280 N, alternatively higher than 320 N. In some embodiments, the puncture resistance max force is lower than 1000 N. In some embodiments, the propylene ethylene copolymer has a tear resistance, machine direction higher than 100N; alternatively higher than 125 N. In some embodiments, the tear resistance, machine direction is lower than 1000 N.

In some embodiments, the propylene ethylene copolymer is used in roofing applications, alternatively single-ply roofing coverings, alternatively membranes.

In some embodiments, the present disclosure provides an article made from or containing the propylene ethylene copolymer. In some embodiments, the article is a blown or cast film or sheet. In some embodiments, the film or sheet is for roofing and geomembrane applications.

The following examples are given to illustrate, not to limit, the present disclosure:

### EXAMPLES

### Xylene-Soluble (XS) Fraction at 25° C.

Xylene Solubles at 25° C. was determined according to ISO 16 152; with solution volume of 250 ml, precipitation at 25° C. for 20 minutes, including 10 minutes with the solution in agitation (magnetic stirrer), and drying at 70° C.

### DSC Method for Melting Point

Melting point was measured according to ISO 11357-3, at scanning rate of 20 C/min both in cooling and heating, on a sample of weight between 5 and 7 mg., under inert N2 flow. The instrument was calibrated with indium.

### Melt Flow Rate (MFR)

Measured according to ISO 1133-1:2012 at 230° C. with a load of 2.16 kg, unless otherwise specified.

### Intrinsic Viscosity (IV)

The sample was dissolved in tetrahydronaphthalene at 135° C. and then poured into a capillary viscometer. The viscometer tube (Ubbelohde type) was surrounded by a cylindrical glass jacket, which permitted temperature control with a circulating thermostatic liquid. The downward passage of the meniscus was timed by a photoelectric device.

The passage of the meniscus in front of the upper lamp started the counter, which had a quartz crystal oscillator. The counter stopped as the meniscus passed the lower lamp, and the efflux time was registered. The efflux time was converted into a value of intrinsic viscosity through Huggins' equation (Huggins, M. L., J. Am. Chem. Soc., 1942, 64, 2716) based upon the flow time of the solvent at the same experimental conditions (same viscometer and same temperature). A single polymer solution was used to determine [f].

### Ethylene Content in the Copolymers

¹³C NMR spectra were acquired on a Bruker AV-600 spectrometer equipped with cryoprobe, operating at 160.91 MHz in the Fourier transform mode at 120° C.

The peak of the Sop carbon (nomenclature according to “Monomer Sequence Distribution in Ethylene-Propylene Rubber Measured by ¹³C NMR. 3. Use of Reaction Probability Mode” C. J. Carman, R. A. Harrington and C. E. Wilkes, Macromolecules, 1977, 10, 536) was used as an internal standard at 29.9 ppm. The samples were dissolved in 1,1,2,2-tetrachloroethane-d2 at 120° C. with an 8% wt/v concentration. Each spectrum was acquired with a 900 pulse, and 15 seconds of delay between pulses and CPD, thereby removing ¹H-¹³C coupling. 512 transients were stored in 32K data points, using a spectral window of 9000 Hz.

The assignments of the spectra, the evaluation of triad distribution and the composition were made according to Kakugo (“Carbon-13 NMR determination of monomer sequence distribution in ethylene-propylene copolymers prepared with 6-titanium trichloride-diethyl-aluminum chloride” M. Kakugo, Y. Naito, K. Mizunuma and T. Miyatake, Macromolecules, 1982, 15, 1150) using the following equations:

$$PPP = 100 T ββ / S PPE = 100 T βδ / S EPE = 100 T δδ / S$$

$$PEP = 100 S ββ / S PEE = 100 S βδ / S EEE = 100 ( 0.25 S γδ + 0.5 S δδ ) / S$$

$$S = T ββ + T β δ + T δ δ + S β β + S β δ + 0.25 S γ δ + 0.5 S δ δ$$

The molar percentage of ethylene content was evaluated using the following equation:

$$E \% mol = 100 * [ PEP + PEE + EEE ]$$

The weight percentage of ethylene content was evaluated using the following equation:

$$100 * E \% mol * MWE$$

$$E \% wt . = E \% mol * MWE + P \% mol * MWP$$

where P % mol is the molar percentage of propylene content, while MWE and MWP are the molecular weights of ethylene and propylene, respectively.

The product of reactivity ratio r1r2 was calculated according to Carman (C. J. Carman, R. A. Harrington and C. E. Wilkes, Macromolecules, 1977; 10, 536) as:

$${r}_{1} {r}_{2} = 1 + ( \frac{E E E + P E E}{P E P} + 1 ) - ( \frac{P}{E} + 1 ) {( \frac{E E E + P E E}{P E P} + 1 )}^{0.5}$$

The tacticity of Propylene sequences was calculated as mm content from the ratio of the PPP mmT_{ββ} (28.90-29.65 ppm) and the whole T_{ββ} (29.80-28.37 ppm).

Preparation of injection molded specimens: Test specimens 80×10×4 mm were obtained according to the method ISO 1873-2:2007.

Preparation of extruded specimens: The polymer, in form of granules, was fed via feed hoppers into a Leonard extruder (mono-screw extruder, 40 mm in diameter and 27 L/D in length). The polymer was melted (melt temperature 230° C.), compressed, mixed, and metered out at a throughput rate of 10 Kg/h with a metering pump (15 cc/rpm). After the molten polymer left the flat die (width 200 mm, die lip at 0.8-0.9 mm), the polymer was cooled through a vertical three-rolls calender, having roll-temperature of 60° C. 1 mm-thick extruded sheets were obtained.
Preparation of compression molded plaques: obtained according to ISO 8986-2:2009.
Flexural modulus: Determined according to the method ISO 178:2019 on injection-molded test specimens.
Tensile Modulus: Determined according to ISO 527-2, and ISO 1873-2 injection-molded test specimens.
Strength and Elongation at break: Determined according to the method ISO 527 on injection-molded test specimens.
Vicat softening temperature: Determined according to the method ISO 306:2013 (A50) on injection-molded specimens.
Charpy Impact test at −40° C.: measured according to ISO 179-1:2010 on injection-molded specimens.
Tensile Modulus (MD and TD): Determined according to the method ISO 527-3:2018 on 1 mm-thick extruded sheets. Specimens type 2, Crosshead speed: 1 mm/min.
Tensile strength and elongation at break (MD and TD) on extruded sheets: Determined according to the method ISO527-3. Specimens type: 5, Crosshead speed: 500 mm/min.
Tear resistance: Determined according to the method ASTM D 1004 on 1 mm-thick extruded sheets. Crosshead speed: 51 mm/min; V-shaped die cut specimen.
Puncture resistance and deformation: Determined according to the method ASTM D 4833 on 1 mm-thick extruded sheets. Punch diameter 8 mm, crosshead speed: 300 mm/min.
Shore A and D on injection molded, compression molded plaques and extruded sheets: Determined according to the method ISO 868 (15 sec).

### Example 1 and Comparative Example 2

### Preparation of the Ziegler-Natta Solid Catalyst Component

The Ziegler-Natta catalyst was prepared as described for Example 5, lines 48-55, of European Patent No. EP728769B1.

### Preparation of the Catalyst System—Precontact

Before introducing the solid catalyst component into the polymerization reactors, the solid catalyst component described was contacted with aluminum-triethyl (TEAL) and dicyclopentyldimethoxysilane (D donor) under the conditions reported in Table 1.

### Prepolymerization

The catalyst system was subjected to prepolymerization treatment at 20° C. by suspending the catalyst system in liquid propylene for a residence time of 9 minutes before introducing the catalyst system into the polymerization reactor.

### Polymerization

The polymerization was carried out in gas-phase polymerization reactor including two interconnected polymerization zones, a riser and a downcomer, as described in European Patent No. EP782587. Hydrogen was used as a molecular weight regulator. The polymer particles exiting from the polymerization step were subjected to a steam treatment, thereby removing unreacted monomers, and dried under a nitrogen flow.

The main precontact, prepolymerization and polymerization conditions and the quantities of monomers and hydrogen fed to the polymerization reactor are reported in Table 1.

TABLE 1

| | | Example 1 | Comp ex 2 |
|---|---|---|---|
| PRECONTACT | | | |
| Temperature | ° C. | 15 | 15 |
| Residence Time | min | 13 | 13 |
| TEAL/catalyst | wt/wt | 6 | 6 |
| TEAL/Ext. Donor | g/g | 4 | 4 |
| PREPOLYMERIZATION | | | |
| Temperature | ° C. | 20 | 20 |
| Residence Time | min | 8 | 8 |
| POLYMERIZATION | | | |
| Temperature | ° C. | 63 | 63 |
| Pressure | bar-g | 22 | 23 |
| Residence Time | min | 100 | 100 |
| Split holdup riser | wt % | 35 | 35 |
| Split holdup downcomer | wt % | 65 | 65 |
| C₂⁻/C₂⁻ + C3⁻ riser | mol/mol | 0.05 | 0.035 |
| C₂⁻/C₂⁻ + C3⁻ downcomer | mol/mol | 0.042 | 0.020 |
| H₂/C₃⁻ riser | mol/mol | 0.040 | 0.07 |
| H₂/C₂⁻ downcomer | mol/mol | 0.047 | 0.017 |

H2 = hydrogen;
C₂− = ethylene,
C₃− = propylene
The properties of the polymers of Ex. 1 and Comp. Ex. 2 are reported in Table 2.

TABLE 2

| Ex | | Ex 1 | Comp Ex 2 |
|---|---|---|---|
| Ethylene content | Wt % | 12.3 | 9.2 |
| Xylene soluble at 25° C. | Wt % | 37.0 | 28.0 |
| Intrinsic viscosity xylene solubles | dl/g | 3.3 | 2.44 |
| MFR | g/10 | 0.5 | 0.5 |
| | min | | |
| Ethylene in the fraction insoluble in xylene | Wt % | 7.2 | 5.1 |
| at 25° C. | | | |
| Ethylene in the fraction soluble in xylene at | Wt % | 23.2 | 21.9 |
| 25° C. | | | |
| PEP sequences in the fraction insoluble in | Mol % | 5.12 | 4.41 |
| xylene at 25° C. | | | |
| PEP sequences in the fraction soluble in | Mol % | 12.28 | 12.31 |
| xylene at 25° C. | | | |
| PEE sequences in the fraction soluble in | Mol % | 11.51 | 10.78 |
| xylene at 25° C. | | | |
| EEE sequences in the fraction soluble in | Mol % | 7.39 | 6.57 |
| xylene at 25° C. | | | |

| | | Ex1 | Comp Ex 2 |
|---|---|---|---|
| Tm | ° C. | 126 | 135 |
| Flex Mod | MPa | 260 | 360 |
| Tensile Mod | MPa | 270 | 370 |
| Yield Stress | MPa | 11.8 | 14.5 |
| Yield El. | % | 23.8 | 19 |
| Stress at break | MPa | 20.4 | 22.7 |
| Ultim elong. | % | 480 | 560 |
| Physico. Mechanical Charact. Roofing | | | |
| Flex Mod Roofing (ISO527-3 Type 2) | MPa | 180 | 250 |
| Yield Stress (type 5A, 500 mm/min), TD | MPa | 11.9 | 15.7 |
| Yield El., TD | % | 22 | 19 |
| Stress @ break, TD | MPa | 27.6 | 25.9 |
| Ultim elong., TD | % | 860 | 770 |
| Tear Resistance, MD Initial, 1 mm | N | 119 | 154 |
| Puncture resist., Max Force | N | 311 | 356 |
| Deformation to break | mm | 42 | 41 |
| Shore A sheet, 15 sec. | | >90 | >90 |
| Shore D, sheet 15 sec. | | 45 | 51 |

TABLE 3
welding

| | Temperature ° C. | | | | |
|---|---|---|---|---|---|
| Welding test 3 m/min | 200 | 240 | 280 | 320 | 360 |

| | | | | |
|---|---|---|---|---|
| EX 1 | BRK | SE1 | SE1 | SE1 |
| comp EX2 | AD | SE1 | SE1 | SE1 |

AD adhesion failure
BRK Break in sheeting
SEI Break in outer edge of seam

The welding test was carried out according to ASTM 6392-8 on a 1 mm thick sheet.

1. A propylene ethylene copolymer having:
i) a xylene soluble fraction at 25° C. ranging from 30 wt % to 48 wt %, based upon the total weight of the propylene ethylene copolymer;
ii) an intrinsic viscosity of the fraction soluble in xylene at 25° C., measured in tetrahydronaphthalene at 135° C., ranging from 2.8 to 4.3 dl/g;
iii) a melt flow rate, MFR, measured according to ISO 1133 at 230° C. with a load of 2.16 kg, ranging from 0.2 g/10 min to 10 g/10 min;
iv) an ethylene derived units content, measured by ¹³C-NMR, ranging from 10.3 wt % to 15.4 wt %, based upon the total weight of the propylene ethylene copolymer;
v) the ethylene derived units content, measured by ¹³C-NMR on the fraction insoluble in xylene at 25° C., ranging from 6.1 wt % to 9.0 wt %, based upon the total weight of the insoluble fraction;
vi) the ethylene derived units content, measured by ¹³C-NMR on the fraction soluble in xylene at 25° C., ranging from 18.2. wt % to 30.2 wt %, based upon the total weight of the soluble fraction;
vii) the C¹³ NMR sequences PEP measured on the fraction insoluble in xylene at 25° C. ranging from 4.1 mol % to 6.5 mol %, and
viii) the C¹³ NMR sequences PEP measured on the fraction soluble in xylene at 25° C. ranging from 10.5 mol % to 14.2 mol %.

2. The propylene ethylene copolymer according to claim 1, wherein the melt flow rate, MFR, measured according to ISO 1133 at 230° C. with a load of 2.16 kg, ranges from 0.3 g/10 min to 8.0 g/10 min.

3. The propylene ethylene copolymer according to claim 1, wherein the xylene soluble fraction at 25° C. ranges from 33 wt % to 45 wt %, based upon the total weight of the propylene ethylene copolymer.

4. The propylene ethylene copolymer according to claim 1, wherein the intrinsic viscosity of the fraction soluble in xylene at 25° C., measured in tetrahydronaphthalene at 135° C., ranges from 3.0 to 4.0 dl/g.

5. The propylene ethylene copolymer according to claim 1, wherein the ethylene derived units content, measured by ¹³C-NMR on the fraction soluble in xylene at 25° C., ranges from 20.2 wt % to 27.8 wt %, based upon the total weight of the soluble fraction.

6. The propylene ethylene copolymer according to claim 1, wherein the ¹³C-NMR sequences PEP measured on the fraction insoluble in xylene at 25° C. ranges from 4.3 mol % to 6.0 mol %; and the ¹³C-NMR sequences PEP measured on the fraction soluble in xylene at 25° C. ranges from 10.9 mol % to 13.8 mol %.

7. The propylene ethylene copolymer according to claim 1, wherein the ¹³C-NMR sequences PEP measured on the fraction insoluble in xylene at 25° C. ranges from 4.8 mol % to 6.0 mol %; and the ¹³C-NMR sequences PEP measured on the fraction soluble in xylene at 25° C. ranges from 11.5 mol % to 13.5 mol %.

8. The propylene ethylene copolymer according to claim 1, wherein the ethylene derived units content, measured by ¹³C-NMR on the fraction insoluble in xylene at 25° C., ranges from 6.3 wt % to 8.3 wt %, based upon the total weight of the insoluble fraction.

9. The propylene ethylene copolymer according to claim 1, wherein the ethylene derived units content, measured by ¹³C-NMR on the fraction soluble in xylene at 25° C., ranges from 22.2 wt % to 26.5 wt %, based upon the total weight of the soluble fraction.

10. The propylene ethylene copolymer according to claim 1, wherein the ¹³C-NMR sequences PEE measured on the fraction soluble in xylene at 25° C. range from 10.3 mol % to 13.0 mol %.

11. The propylene ethylene copolymer according to claim 1, wherein the ¹³C-NMR sequences EEE measured on the fraction soluble in xylene at 25° C. are lower than 9.0 mol %.

12. The propylene ethylene copolymer according to claim 1, wherein the ¹³C-NMR sequences EEE measured on the fraction soluble in xylene at 25° C. ranges from 4.5 mol % to 8.5 mol %.

13. The propylene ethylene copolymer according to claim 1, wherein the ¹³C-NMR sequences PEE measured on the fraction soluble in xylene at 25° C. range from 10.8 mol % to 12.5 mol %.

14. An article of manufacture comprising:
a sheet or membrane comprising the propylene ethylene copolymer according to claim 1.

15. The article of manufacture according to claim 14, wherein the article is a geomembrane.
